(19) United States
(12) Patent Application Publication
(10) Pub. No.: US 2007/0298241 A1
(43) Pub. Date: Dec. 27, 2007

(54) MULTI-LAYERED ANISOTROPIC CONDUCTION ACTION FILM AND PREPARING METHOD THEREOF

(76) Inventor: Ping LIU, Shenzhen (CN)

Correspondence Address: PEARNE & GORDON LLP, 1801 EAST 9TH STREET, SUITE 1200, CLEVELAND, OH, 44114-3108, US

(21) Appl. No.: 11/752,454

(22) Filed: May 23, 2007

(30) Foreign Application Priority Data
May 25, 2006 (CN) 200610021066.4

(51) Int. Cl. B32B 5/16; B32B 27/32

(52) U.S. Cl. 428/323; 428/523; 428/413; 428/500

(57) ABSTRACT

A functional multi-layered anisotropic conduction action film (ACAF) and a preparing method thereof are provided. The functional multi-layered ACAF includes a resin surface monomer coating layer, a metal particle resin layer, a low-temperature hot-melt resin layer with desirable insulating property. The monomer layer is of butyl acrylate, methyl acrylate, diethanol acrylate, and 2-ethyl percaproate tetramethyl butyl. The metal particle resin layer and the low-temperature hot-melt resin layer are of phenoxy resin, novolac epoxy resin, acrylate rubber, styrene-butadiene rubber elastomer, long chain imidazole derivatives, conductive particles (MICROPEARL AV). Various resins are copolymerized in a toluene/ethyl acetate mixed solvent, and then coated, so as to get a high-precision ACAF, and the chemical property, physical property, and electrical property thereof can meet the joining requirements for binding and packaging a 0.18-0.13 μm chip with a high-density COF circuit.

### BACKGROUND OF THE INVENTION

1. Field of the Invention

The present invention relates to a functional multi-layered anisotropic conduction action film (ACAF) and a preparing method thereof, which is applicable for the preparation of a copolymer resin.

2. Description of Related Art

As electronic devices are getting smaller, lighter, and thinner, the demands for functional joining materials is greatly increased as the increasing needs for the connection between fine circuits and the piggybacking connection between the micro device and the precision circuit. As the requirements for the functional joining materials becomes higher and higher, the fine wiring is required to be directly connected or bond with the chip, and the joining material is required to have a high flexibility in the high-density assembling. Accordingly, the anisotropic conductive film (ACF) has appeared. Currently, the overall ACF market has exceeded over 20 billion, which has become a major factor for LCD to support the society development.

In the current development of ACF, the ACF with a line pitch and line width of about 100 μm is generated used; various adhesive resins, a coupling agent and a silicon powder filler are used in TAP and COG, for example, JP03129607, JP08325543, and JP0931419. In addition, a preparation method mentioned in some references about ACF, for example, CN99807810.7, U.S. Pat. No. 5,240,761, U.S. Pat. No. 4,113,981, U.S. Pat. No. 5,180,888, U.S. Pat. No. 5,240,761, and U.S. Pat. No. 4,737,112, includes: firstly, engraving a hole on a film; next, placing conductive particles, and then coating, so as to form a conductive film.

The requirements for high-density wiring, high-speed joining, and thin type assembling focus on front-end components, without punching or welding. However, the current ACF with a line width of about 100 μm cannot meet the requirements. Therefore, it becomes very important for disposing a functional multi-layered ACAF in the chip and the chip on glass, the high-density FPC and COF. How to select the optimum technique and the optimum material formulation to prepare an ACAF with an excellent performance, a low cost, and in synchronized with the semiconductor chip technique are important technical issue. The development of the functional mulit-layered ACAF is beneficial for the expansion of the LCD market.

In the current technique, though the ACF includes multi-layered or double-layered ACF, which are laminated and adhered by a adhesive, as that mentioned in JP2001171033, the first layer and the second layer are coated with resins in different proportion, so as to form thin films. As disclosed in Japanese Patent No. 200178511, the coating is repeated for four times, in order to prepare a multi-layered ACF, including the first layer of a multi-layered anisotropic conductive adhesive, the second layer of an insulating layer, the third layer of an anisotropic conductive adhesive, and the forth layer of an insulating layer. However, this technical cannot achieve the ACF with a line width and pitch of 10 μm.

### SUMMARY OF THE INVENTION

Accordingly, the present invention is directed to solving the problem of binding and packaging a chip with a micro line width/space (for example, 0.18 μm) with a high-density COF, so as to ensure a high insulating property in the micro electrode space of 10 μm.

In order to achieve the above objective, the present invention provides a functional multi-layered anisotropic conduction action film (ACAF) and a preparing method thereof. The ACAF includes a monomer coating layer, a low-temperature hot-melt resin layer, and a conductive particle layer. The monomer coating layer includes butyl acrylate, methyl acrylate, diethanol acrylate, and tetramethyl butyl 2-ethyl percaproate. The low-temperature hot-melt resin layer includes phenoxy, novolac epoxy resin, acrylate rubber, and styrene-butadiene rubber elastomer, and a long chain imidazole derivative. The conductive particle layer includes MICROPEARL AV conductive particles and low-temperature hot-melt micro-encapsulation resin layer. The mixed solvent used in the preparation is toluene/ethyl acetate, which is coated, dried, and cut, to get ACAF, i.e., the anisotropic conduction action film.

The low-temperature hot-melt resin of the present invention contains: phenoxy of YP-70 at 10-30 parts by weight; novolac epoxy resin of F-51 F-44 at 10-20 parts by weight; acrylate rubber with a volume density of 0.48±0.1 g/cc, a volatility of <1.0%, Tg of −30° C., and a solution viscosity (Mega Pascal, MPa, seconds, s, 25° C.) of 5000-10000; acrylate rubber at 10-20 parts by weight; styrene-butadiene rubber elastomer SBR1502 with a raw rubber Mooney viscosity ML^{100° C.} (1+4) of 45-55, a 300% fixed elongation MPa (35 minutes) of 14.1-18.6, a tensile strength MPa (35 minutes) of >23.7, an elongation at break (%) (35 minutes) of >415, at 5-10 parts by weight; long chain imidazole derivative of an isocyanate derivative of 2,4-diamino-6-[-2-+hendecylimidazolyl(1)]-ethyl+cis-triazine (with a trade No. of C₁₁Z-AZINE) and 1-cyanoethyl-2-+hendecyl-imidazole trimellitate (with a trade No. of C₁₁Z-CNS) at 0.75-5 parts by weight; conductive particles with an average diameter selected from the group consisting of 3 μm±0.05, 3.25 μm±0.05, 3.50 μm±0.05, 3.75 μm±0.05, and 4 μm±0.05, at a weight of 30-40 g particles per 500 g of total weight, and a solution with a solid content of 20%-40%, formulated by mixing a solvent of toluene/ethyl acetate (4:6).

The monomer of the present invention is used to adjust the consistency of the coating layer on the ACAF surface, which adjusts the softness, hardness, and the pre-bonding curing time according to various chips. The copolymer is applicable for the solution polymerization of other resins depending upon the monomer component combination and the tolerance factor. Due to the advantages of narrow distribution range of molecular weight, less oligomer residues and impurities, the copolymer can be used together with isocyanate and epoxy by introducing the functional group, so as to improve the cohesive property, and to enhance the film strength, the solvent resistance, and the moisture resistance of the ACAF, and thus preventing foaming. The monomer is butyl acrylate, methyl acrylate, ethanol acrylate, and tetramethyl butyl 2-ethyl percaproate (the initiator) with a weight ratio of 7:3:2:1 according to the requirements of the chip.

The long chain imidazole derivative is prepared by reacting 2,4-diamino-6-[-2-hendecylimidazolyl(1)-ethyl+cis-triazine and 1-cyanoethyl-2-+hendecyl-imidazole trimellitate in a proportion of 1:1 for 3 hours, and heating at 50° C., adding toluene-2; 4-diisocyanate; and a mixed solvent in a weight ratio of 30:0.8:60, and then reacting for 5 hours. Due to containing the long chain, the imidazole derivative has a latent property and a long shelf life, which thus can be fast cured at a certain temperature over a certain time period by micro-encapsulation.

The thermal aging property of the elastomer is improved by mixing 1) acrylate rubber and styrene-butadiene rubber (SBR1502) in a proportion of 10:5; and then mixing with a micro amount of 2) a basic reinforcing agent, white carbon black, and 3) a silicone coupling agent, quaternary ammonium salt, in a weight ratio of 1:0.2:0.3 through a physical manner, and then milling them together. The acrylate rubber is used as an impact modifier to improve the impact strength of acrylic acid, the high thermal stability, and the weathering resistance. Due to the excellent processability, hardness, and retentivity, the ACAF resin has a low elasticity ratio, so that the viscosity is enhanced while the stress is buffered, so as to improve the interface influence upon adding the conductive particles into the resin solution, and thus, the conductive particles are uniformly distributed.

In the present invention, the copolymer is prepared through a process of suspension polymerization. A treated solution of phenoxy, novolac epoxy, and a mixed solvent is added into a reactor according to the above-described formula, stirred and dissolved; then, an elastomer mixed resin is added, stirred, and mixed in a stirring device; and then, acrylate rubber and a mixed solvent are added, stirred to dissolve. After the polymer viscosity is reduced to a certain level, a long chain imidazole derivative is added, and stirred in a stirring device continuously. After stirring by counting in a stirring device, conductive particles, and a mixed solution of monomers are added, so as to prepare the copolymer in the presence of an initiator of tetramethyl butyl 2-ethyl percaproate. Then, the copolymer is stirred to defoam, coated onto a surface-treated milky-white polyester film at the coating temperature of 100° C.-135° C. over 8 minutes, separated by a separating member, and then wound-up, cut, and rewound, and thus, the ACAF is obtained by means of winding-up.

An ACAF stirring device of the present invention employs a triple-action multi-degree-of-freedom stirring device, invented by the same applicant, with Patent Application No. 200310111757, for capturing, locating, and stirring, in which according to the polymer viscosity, the conductive particles are dispersed and the average particle size distribution is determined, and particularly, the stirring device can measure the viscosity by auto-counting, so that the conductive particles can be uniformly suspended and distributed in the mixed solution of the polymer hot-melt resin, the elastomer resin, and the monomer, and a viscous surface layer is formed on the ACAF surface, so as to get a functional multi-layered ACAF joining material, which meets the requirements.

The multi-layered ACAF of the present invention can join and install the liquid crystal driving IC directly to the high-density FPC circuit, so as to integrate and miniaturize the COF, TAB, and COG chip, so that the chip leg has a high intact rate at a line width/space of 0.18 μm. The thermal curing shrinkage ratio of the resin, the deviation in location, short circuit, and the chip damage can meet the requirements. Therefore, the present invention is a preparing method for microelectronics packaging, binding, and functional joining.

The multi-layered ACAF allow the line width and space of the display, semiconductor, CHIP, and the FPC substrate to fall between a level of 10 μm. As a low-temperature joinable material, the multi-layered ACAF has advantages of being free of lead and environmental protective, and has become the pioneer product of assembly materials for adjusting environment, which can make the IC card, the detection in the high-frequency field, and the remote sensing and radio frequency electronic labels be more functionalized and convenient.

For the joining between the ACAF and the wire, the resistor sequentially connects a raised electrode to the circuit, so that the electrode contact area can be reduced to a large extent. The tiny raised electrode can capture sufficient conductive particles to ensure the conduction, and to ensure the insulating property for each electrode. As for the fine pitch joining, the adhesion, insulation, and conduction functions are separated. The anisotropic conductive component is in direct proportion to the amount of conductive particles on the raised electrode. The adhesion layer and the conductive particle layer of the ACAF are delaminated, so that the adhesion, insulation, and conduction functions are separated. Compared with other ACF, the conductive particles of the ACAF of the present invention have a higher efficiency, the electrode has a higher capture rate, and the conductive particles flowing out of the electrode space are increasingly less. Due to the difference between the thermal expansion coefficient of the chip and that of the substrate of the ACAF, the mechanical internal stress generated can enhance the viscosity, while buffering the internal stress through the low elasticity ratio. Therefore, the joining action is performed at a high sensitivity, without requiring the punching process, which is free of lead, halogen, and solder, and be used for manufacturing a multi-layered component.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### DESCRIPTION OF EMBODIMENTS

The present invention is further described through the following embodiments.

The basic formula of the copolymer of the present invention is listed as follows:

| | | |
|---|---|---|
| Phenoxy YP-70 resin | 10–30 | parts |
| Novolac F-55 F-44 epoxy resin | 10–20 | parts |
| Acrylate rubber | 10–20 | parts |
| Rubber elastomer resin | 5–10 | parts |
| Long chain imidazole derivative | 0.75–5 | parts |
| Monomer solution | 5–10 | parts |
| Conductive particle | 30–40 | parts |
| Mixed solvent, toluene/ethyl acetate | | |
| (at a weight ratio of 4:6), formulated | | |
| into a solution with a solid | | |
| content of 20%–40% | | |
| Density of the conductive particles | 1.2 | g/cm³ |
| added into the solution | | |
| Solution viscosity | 5000–10000 | (MPa · s 25° C.) |

### Embodiment 1

20 parts of Phenoxy YP-70 were added into 200 parts of the mixed solvent, and stirred to dissolve in a reactor. Next, 15 parts of novolac mixed resin were added; after stirring to completely dissolve, 5 parts of rubber elastic mixed resin were added, and stirred to dissolve continuously. Then, 20 parts of acrylate rubber and 200 parts of the mixed solvent were added, and stirred to dissolve. Then, 3 parts of imidazole derivative were added, heated at 50° C. and stirred for 2 hours. According to the weight ratio of the copolymer to be prepared, 30 parts of 5 μm conductive particles and 10 parts of a prepared mixed monomer solution (based on 10% of the copolymer) were added, stirred by a triple-action multi-degree-of-freedom stirring device uniformly, so as to make a viscosity and a density distribution of the conductive particles fall within a certain range, and then coated at a coating temperature that changes from 100° C. to 130° C. and then drops to 120° C. over 6-8 minutes, and wound-up on a surface-treated milky-white polyester film to be cut and rewound, and thus getting an ACAF with a width of 0.03 mm-0.015 mm, a length of 50 meters (m)/roll through winding up.

According to a basic formula the same as that mentioned above, a cut FOG series of ACAF was obtained by adjusting the monomer solution.
Model: DBL SOFG200 product FOG (flexible printed circuit board on glass)
Thickness: 20 μm
Length: 50 m/roll to 100 m/roll
Width: 1.5 mm
Material of the conductive particles: conductive gold
Density of the conductive particles: 48 10⁴/mm³
Minimum pitch capability: 50 pitch
Pre-bonding conditions:
Temperature: 85° C.±5° C.
Pressure: 1.2 MPa
Time: 2 seconds
Main bonding conditions
Temperature: 187° C.
Pressure: 0.13 MPa
Time: 18 seconds
Obtained results meeting FOG requirements
On-resistance: 1.2 Ω
Insulation resistance: 10¹²
Bond strength: 60 N/m
Storage time: 7 months/−10° C. to 5° C.

### Embodiment 2

20 parts of Phenoxy YP-70 were added into 200 parts of the mixed solvent, and stirred to dissolve in a reactor. Next, 15 parts of novolac mixed resin were added; after stirring to dissolve completely, 5 parts of rubber elastic mixed resin were added, and stirred to dissolve continuously. Then, 20 parts of acrylate rubber and 200 parts of the mixed solvent were added, and stirred to dissolve. Then, 3 parts of imidazole derivative were added, heated at 50° C. and stirred for 2 hours. According to the weight ratio of the copolymer to be prepared, 30 parts of 4 μm conductive particles and 10 parts of a prepared mixed monomer solution (based on 20% of the copolymer) were added, stirred by a triple-action multi-degree-of-freedom stirring device uniformly, so as to make a viscosity and a density distribution of the conductive particles fall within a certain range, and then coated at a coating temperature that changes from 100° C. to 130° C. and then drops to 120° C. over 6-8 minutes, and wound-up on a surface-treated milky-white polyester film to be cut and rewound, and thus getting an ACAF with a width of 0.03 mm-0.015 mm, a length of 50 m/roll through winding up.

According to a basic formula the same as that mentioned above, a cut COF (Chip on Foil) series of ACAF was obtained by adjusting the monomer solution.
Model: DBL-40CT product COF
Thickness: 23 μm
Length: 50 m/roll to 100 m/roll
Width: 1.5-6 mm
Size of the conductive particles: 4 μm
Density of the conductive particles: 130 10⁴/mm³
Minimum pitch capability: 30 pitch
Pre-bonding conditions:
Temperature: 85° C.±5° C.
Pressure: 1 MPa
Time: 5 seconds
Main bonding conditions:
Temperature: 205° C.
Pressure: 50 MPa
Time: 16 seconds
Obtained results meeting COF requirements
On-resistance: >0.2 Ω
Insulation resistance: 10¹² Ω
Bond strength: 60 N/m
Storage time: 6 months/−10° C. to 5° C.

### Embodiment 3

20 parts of Phenoxy YP-70 were added into 200 parts of the mixed solvent, and stirred to dissolve in a reactor. Next, 15 parts of novolac mixed resin were added; after stirring to dissolve completely, 5 parts of rubber elastic mixed resin were added, and stirred to dissolve continuously. Then, 20 parts of acrylate rubber and 200 parts of the mixed solvent were added, and stirred to dissolve. Then, 3 parts of imidazole derivative were added, heated at 50° C. and stirred for 2 hours. According to the weight ratio of the copolymer to be prepared, 30 parts of 3 μm conductive particles and 10 parts of a prepared mixed monomer solution (based on 30% of the copolymer) were added, stirred by a triple-action multi-degree-of-freedom stirring device uniformly, so as to make a viscosity and a density distribution of the conductive particles fall within a certain range, and then coated at a coating temperature that changes from 100° C. to 130° C. and then drops to 120° C. over 6-8 minutes, and wound-up on a surface-treated milky-white polyester film to be cut and rewound, and thus getting an ACAF with a width of 0.03 mm-0.015 mm, a length of 50 m/roll through winding up.

According to a basic formula the same as that mentioned above, a cut COG series of ACAF was obtained by adjusting the monomer solution.
Model: DBL-30CG product COG
Thickness: 30 μm
Length: 50 m/roll to 100 m/roll
Width: 1.5 mm
Size of the conductive particles: 3 μm
Density of the conductive particles: 180 10⁴/mm³
Minimum pitch capability: 15 μm-20 μm
Pre-bonding conditions:
Temperature: 80° C.±5° C.
Pressure: 1 MPa
Time: 3 seconds
Main bonding conditions:
Temperature: 210° C.
Pressure: 60 MPa
Time: 19 seconds
Obtained results meeting COG requirements:
On-resistance: >0.1 Ω
Insulation resistance: 10¹²⁺Ω
Bond strength: 60 N/m
Storage time: 5 months/−10° C. to 5° C.

### COMPARATIVE EXAMPLE 1

20 parts of Phenoxy YP-70 were added into 200 parts of the mixed solvent, and stirred to dissolve in a reactor. Next, 15 parts of novolac mixed resin were added; after stirred to dissolve, 20 parts of acrylate rubber and 200 parts of the mixed solvent were added, and stirred to dissolve. Then, 3 parts of imidazole derivative were added, heated at 50° C. and stirred for 2 hours. According to the weight ratio of the copolymer to be prepared, 30 parts of 5 μm conductive particles and 10 parts of a prepared mixed monomer solution (based on 10% of the copolymer) were added, stirred by a triple-action multi-degree-of-freedom stirring device uniformly, so as to make a viscosity and a density distribution of the conductive particles fall within a certain range, and coated at a coating temperature that changes from 100° C. to 130° C. and then drops to 120° C. over 6-8 minutes, and wound-up on a surface-treated milky-white polyester film to be cut and rewound, and thus getting an ACAF with a width of 0.03 mm-0.015 mm, and a length of 50 m/roll through winding up.

According to the same basic formula, without the styrene-butadiene rubber elastomer, a cut FOG series of ACAF was obtained by adjusting the monomer solution.
Model: DBL SOFG200 product FOG
Thickness: 20 μm
Length: 50 m/roll to 100 m/roll
Width: 1.5 mm
Material of the conductive particles: conductive gold
Density of the conductive particles: 48 10⁴/mm³
Minimum pitch capability: 50 pitch
Pre-bonding conditions:
Temperature: 85° C.±5° C.
Pressure: 1.2 MPa
Time: 2 seconds
Main bonding conditions:
Temperature: 187° C.
Pressure: 0.13 MPa
Time: 18 seconds
Obtained results:
On-resistance: 1.0 Ω
Insulation resistance: 10¹¹ Ω
Bond strength: 30 N/m
Storage time: 5 months/−10° C. to 5° C.
Yield: 30%

### COMPARATIVE EXAMPLE 2

20 parts of Phenoxy YP-70 were added into 200 parts of the mixed solvent, and stirred to dissolve in a reactor. Next, 15 parts of novolac mixed resin were added; after stirred to dissolve completely, 5 parts of rubber elastic mixed resin were added, and stirred continuously to dissolve. Then, 20 parts of acrylate rubber and 200 parts of the mixed solvent were added, and stirred to dissolve. Then, 3 parts of imidazole derivative were added, heated at 50° C. and stirred for 2 hours. According to the weight ratio of the copolymer to be prepared, 30 parts of 4 μm conductive particles were added, stirred by a triple-action multi-degree-of-freedom stirring device uniformly, so as to make a viscosity and a density distribution of the conductive particles fall within a certain range, and then coated at a coating temperature that changes from 100° C. to 130° C. and then drops to 120° C. over 6-8 minutes, and wound-up on a surface-treated milky-white polyester film to be cut and rewound, and thus getting an ACAF with a width of 0.03 mm-0.015 mm, and a length of 50 m/roll through winding up.

According to the same basic formula, without the monomer solution, a cut COF series of ACAF was obtained.
Model: DBL-4OCT product COF
Thickness: 23 μm
Length: 50 m/roll to 100 m/roll
Width: 1.5-6 mm
Size of the conductive particles: 4 μm
Density of the conductive particles: 130 10⁴/mm³
Minimum pitch capability: 30 pitch
Pre-bonding conditions:
Temperature: 85° C.±5° C.
Pressure: 1 MPa
Time: 5 seconds
Main bonding conditions:
Temperature: 205° C.
Pressure: 1 MPa
Time: 5 seconds
Obtained COF results:
On-resistance: >0.7 Ω
Insulation resistance: 10⁸ Ω
Bond strength: 40 N/m
Storage time: 5 months/−10° C. to 5° C.
Yield: 90%

### COMPARATIVE EXAMPLE 3

20 parts of Phenoxy YP-70 were added into 200 parts of the mixed solvent, and stirred to dissolve in a reactor. Next, 15 parts of novolac mixed resin were added; after stirred to dissolve completely, 5 parts of rubber elastic mixed resin were added, and stirred continuously to dissolve. Then, 200 parts of the mixed solvent were added, and stirred to dissolve. Then, 3 parts of imidazole derivative were added, heated at 50° C. and stirred for 2 hours. According to the weight ratio of the copolymer to be prepared, 30 parts of 3 μm conductive particles and 10 parts of a prepared mixed monomer solution (based on 30% of the copolymer) were added, stirred by a triple-action multi-degree-of-freedom stirring device uniformly, so as to make a viscosity and a density distribution of the conductive particles fall within a certain range, and coated at a coating temperature that changes from 100° C. to 130° C. and then drops to 120° C. over 6-8 minutes, and wound-up on a surface-treated milky-white polyester film to be cut and rewound, and thus getting an ACAF with a width of 0.03 mm-0.015 mm, and a length of 50 m/roll through winding up.

According to the same basic formula, without the acrylate rubber, a cut COG series of ACAF was obtained by adjusting the monomer solution.
Model: DBL-3OCG product COG
Thickness: 30 μm
Length: 50 m/roll to 100 m/roll
Width: 1.5 mm
Size of the conductive particles: 3 μm
Density of the conductive particles: 180 10⁴/mm³
Minimum pitch capability: 15 μm-20 μm
Pre-bonding conditions:
Temperature: 85° C.±5° C.
Pressure: 1 MPa
Time: 3 seconds
Main bonding conditions:
Temperature: 210° C.
Pressure: 60 MPa
Time: 19 seconds
Obtained COG results:
On-resistance: >0.1 Ω
Insulation resistance: 10¹¹ Ω
Bond strength: 10 N/m
Storage time: 7 days/−10° C. to 5° C.
Yield: 0

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A functional multi-layered anisotropic conduction action film (ACAF), comprising a monomer coating layer, a low-temperature hot-melt resin layer, and a conductive particle layer, wherein the monomer coating layer comprises butyl acrylate, methyl acrylate, diethanol acrylate, and tetramethyl butyl 2-ethyl percaproate; the low-temperature hot-melt resin layer comprises phenoxy, novolac epoxy resin, acrylate rubber, a mixed elastomer of acrylate rubber and styrene-butadiene rubber, and a long chain imidazole derivative; and the conductive particle layer comprises conductive particles.

2. The functional multi-layered ACAF as claimed in claim 1, wherein the specific substance and content of each component in the low-temperature hot-melt resin layer are:
phenoxy at a weight of 10-30 parts;
novolac epoxy resin at a weight of 10-20 parts;
acrylate rubber, at a volume density of 0.48±0.1 g/cc, a volatility of <1.0%, Tg of −30° C. , a solution viscosity (MPa s25° C. ) of 5000-10000, 10-20 parts;
styrene-butadiene rubber elastomer in the mixed elastomer, at a raw rubber Mooney viscosity ML^{100° C.} (1+4) of 45-55, a 300% fixed elongation MPa (35 minutes) of 14.1-18.6, a tensile strength MPa (35 minutes) of >23.7, an elongation at break (%) (35 minutes) of >415, a eight of the mixed elastomer of 5-10 parts;
the long chain imidazole derivative as an isocyanate derivative of 2,4-diamino-6-[-2-+hendecylimidazolyl(1)]-ethyl+cis-triazine and 1-cyanoethyl-2-+hendecyl-imidazole trimellitate, at a weight of 0.75-5 parts.

3. The functional multi-layered ACAF as claimed in claim 1, wherein the conductive particles have a diameter selected from the group consisting of 3 μm±0.05, 3.25 μm±0.05, 3.50 μm±0.05, 3.75 μm±0.05, and 4 μm±0.05, and a content of 30-40 parts of particles per 500 parts of total weight.

4. The functional multi-layered ACAF as claimed in claim 2, wherein the conductive particles have a diameter selected from the group consisting of 3 μm±0.05, 3.25 μm±0.05, 3.50 μm±0.05, 3.75 μm±0.05, and 4 μm±0.05, and a content of 30-40 parts of particles per 500 parts of total weight.

5. The functional multi-layered ACAF as claimed in claim 1, wherein the monomer has a content of 5-10 parts of monomer per 500 parts of total weight, and the weight ratio of butyl acrylate, methyl acrylate, ethanol acrylate, and tetramethyl butyl 2-ethyl percaproate is 7:3:2:1

6. The functional multi-layered ACAF as claimed in claim 2, wherein the monomer has a content of 5-10 parts of monomer per 500 parts of total weight, and the weight ratio of butyl acrylate, methyl acrylate, ethanol acrylate, and tetramethyl butyl 2-ethyl percaproate is 7:3:2:1

7. A method for preparing a functional multi-layered anisotropic conduction action film (ACAF), wherein a copolymer is prepared by a suspension polymerization, comprising:
A. adding a solution of phenoxy, novolac epoxy, and a solvent for said phenoxy and said novolac epoxy into a reactor, and stirring to dissolve;
B. adding an elastomer mixed resin, mixing and stirring in a stirring device;
C. adding acrylate rubber and a mixed solvent, and stirring to dissolve;
D. after the polymer viscosity has been reduced to a certain level, adding a long chain imidazole derivative, and stirring in a stirring device continuously;
E. adding conductive particles and a mixed solution of monomers after stirring by counting in a stirring device, to prepare the copolymer in the presence of an initiator of tetramethyl butyl 2-ethyl percaproate;
F. stirring to defoam, and coating on a surface-treated milky-white polyester film at the coating temperature of 100° C.-135° C. for 6-10 minutes, separating with a separating member, and then winding-up, cutting, and rewinding, so as to obtain the functional multi-layered ACAF through winding-up.

8. The method for preparing the functional multi-layered ACAF as claimed in claim 5, wherein the specific substance and content of each added component are:
Phenoxy at a weight of 10-30 parts;
novolac epoxy resin at a weight of 10-20 parts;
acrylate rubber, at a volume density of 0.48±0.1 g/cc, a volatility of <1.0%, Tg of −30° C., a solution viscosity (MPa s25° C.) of 5000-10000, 10-20 parts;
styrene-butadiene rubber elastomer in the mixed elastomer, at a raw rubber Mooney viscosity ML^{100° C.} (1+4) of 45-55, a 300% fixed elongation MPa (35 minutes) of 14.1-18.6, at a tensile strength MPa (35 minutes) of >23.7, an elongation at break (%) (35 minutes) of >415, a weight of the mixed elastomer of 5-10 parts;
the long chain imidazole derivatives of an isocyanate derivative of 2,4-diamino-6-[-2-+hendecylimidazolyl(1)]-ethyl+cis-triazine and 1-cyanoethyl-2-+hendecyl-imidazole trimellitate, at a weight of 0.75-5 parts;
the conductive particle with a diameter selected from the group consisting of 3 μm±0.05, 3.25 μm±0.05, 3.50 μm±0.05, or 3.75 μm±0.05, and 4 μm±0.05, and a content of 30-40 parts of particles per 500 parts of total weight;
the monomer at a content of 5-10 parts of the monomer per 500 parts of total weight, wherein the weight ratio of butyl acrylate, methyl acrylate, ethanol acrylate, and tetramethyl butyl 2-ethyl percaproate is 7:3:2:1.

9. The method for preparing the functional multi-layered ACAF as claimed in claim 5, wherein the long chain imidazole derivative is prepared by reacting 2,4-diamino-6-[-2-hendecylimidazolyl(1)-ethyl+cis-triazine and 1-cyanoethyl-2-+hendecyl-imidazole trimellitate in a proportion of 1:1 for 3 hours, and heating at 50° C., adding toluene-2; 4-diisocyanate; and a solvent for toluene-2 and 4-diisocyanate, at a weight ratio of 30:0.8:60, and then reacting for 5 hours.

10. The method for preparing the functional multi-layered ACAF as claimed in claim 6, wherein the long chain imidazole derivative is prepared by reacting 2,4-diamino-6-[-2-hendecylimidazolyl(1)-ethyl+cis-triazine and 1-cyanoethyl-2-+hendecyl-imidazole trimellitate in a proportion of 1:1 for 3 hours, and heating at 50° C., adding toluene-2; 4-diisocyanate; and a mixed solvent at a weight ratio of 30:0.8:60, and then reacting for 5 hours.

11. The method for preparing the functional multi-layered ACAF as claimed in claim 5, wherein the thermal aging property of the elastomer is improved by means of mixing 1) acrylate rubber and styrene-butadiene rubber in a proportion of 10:5, and then mixing with 2) a basic reinforcing agent, white carbon black, and 3) a silicone coupling agent, quaternary ammonium salt, at a weight ratio of 1:0.2:0.3 through a physical manner and then milling them together.

12. The method for preparing the functional multi-layered ACAF as claimed in claim 6, wherein the thermal aging property of the elastomer is improved by means of mixing 1) acrylate rubber and styrene-butadiene rubber in a proportion of 10:5, and then mixing with 2) a basic reinforcing agent, white carbon black, and 3) a silicone coupling agent, quaternary ammonium salt, at a weight ratio of 1:0.2:0.3 through a physical manner and then milling them together.

13. The method for preparing the functional multi-layered ACAF as claimed in claim 5, wherein the mixed solvent is a solution at a weight of 20%-40% formulated by mixing toluene and ethyl acetate in a proportion of 4:6.

14. The method for preparing the functional multi-layered ACAF as claimed in claim 6, wherein the mixed solvent is a solution at a weight of 20%-40% formulated by mixing toluene and ethyl acetate in a proportion of 4:6.
